(19) United States
(12) Patent Application Publication
(10) Pub. No.: US 2003/0009366 A1
(43) Pub. Date: Jan. 9, 2003

(54) System and related methods to facilitate dynamically collaborative commerce over a data network

(76) Inventors: Anthony Haber, Beaverton, OR (US); Bridget Townsend, Hillsboro, OR (US); David Hillis, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/898,896

(22) Filed: Jul. 3, 2001

(51) Int. Cl. G06F 17/60

(52) U.S. Cl. 705/9

(57) ABSTRACT

A system and related methods facilitating dynamically collaborative electronic commerce over a data network is presented. In this regard, according to one embodiment, an apparatus is presented comprising a collaboration agent, to provide an interface through which digitally disparate sellers, dealers and/or manufacturers agree to selectively participate in commercial transactions for requesting users, and to enable each of the sellers, dealers and/or manufacturers to define terms and conditions under which they selectively participate with one another to facilitate commercial collaboration between these otherwise digitally disparate providers.

### TECHNICAL FIELD

This invention generally relates to data networking and, more particularly to a system and related methods to facilitate dynamically collaborative commerce over a data network.

### BACKGROUND

The use of data networks to facilitate commerce is not new. Indeed, the emergence of the Internet has fostered a whole new era in electronic commerce. It is interesting, however, that the sales model used on the Internet for a particular industry often mirrors that of the more traditional “brick and mortar” business model. That is, the manufacturer of a product establishes their own retail (or electronic retail (e-tail), in the case of an electronic market) distribution, and/or direct business relationships with individual resellers. In this regard, a server providing a web site for a particular seller will only sell the products of those dealers/manufacturers with whom they have developed individual business relationships. A block diagram illustrating a data network facilitating such conventional electronic commerce is generally presented with reference to FIG. 1.

FIG. 1 is a block diagram of a data network facilitating conventional electronic commerce. In accordance with the illustrated block diagram of FIG. 1, data network 100 is presented comprising one or more retail servers 102 coupled to one or more dealer servers 104 and/or manufacturer servers 106 via a network communication means (e.g., wide area network (WAN), public data network (Internet), local area network (LAN), etc.) 108. In accordance with conventional practices, each of the seller server(s) 102 have contracted with select dealers 104 and/or manufacturers 106 to sell products provided by the dealers/manufacturers. To facilitate this commercial relationship, the parties must agree on communication protocols, data formats, and the like in order to communicate between one another. As shown, certain of the dealers 104 and/or manufacturers 106 may also provide their own seller server(s) 112. Each of the dealer servers 104 and/or manufacturer servers 106 are communicatively coupled to an inventory database 114, and/or a product database(s) 116, which maintains an inventory of available products and/or product configurations available for sale by sellers 102/112 to requesting users 118.

In accordance with this traditional e-tail model, a user 116 accesses a seller server 102/112 searching for a particular product configuration. However, insofar as the provider of the seller server 102/112 has only contracted with a limited number of dealers/manufacturers, a search for a particular product or product configuration on any given seller server 102/112 will only yield a small subset of all such products which may otherwise be available through other dealers/manufacturers with which the seller server 102/112 has not contracted.

To overcome this limitation, other informational sites, e.g., servers implementing search engines, can be leveraged by a user to attempt to find a site associated with a product they are seeking. Those skilled in the art will appreciate, however, that such servers do not offer e-tail services. Consequently, a user is left to stumble from web-site to web-site searching for a product, or product configuration of interest; not so unlike a consumer in the traditional brick and mortar context. In this regard, the conventional electronic commerce business model has failed to deliver on a promise of truly global markets.

Thus, an improved electronic commerce model is required. More particularly, a system and related methods facilitating collaborative commerce over a data network is required, unencumbered by the limitations commonly associated with conventional electronic commerce implementations. Just such a system and related methods are introduced below.

### SUMMARY

A system and related methods facilitating dynamically collaborative electronic commerce over a data network is presented. In this regard, according to one embodiment, an apparatus is presented comprising a collaboration agent, to provide an interface through which digitally disparate sellers, dealers and/or manufacturers agree to selectively participate in commercial transactions for requesting users, and to enable each of the sellers, dealers and/or manufacturers to define terms and conditions under which they selectively participate with one another to facilitate commercial collaboration between these otherwise digitally disparate providers.

### BRIEF DESCRIPTION OF THE DRAWINGS

The present invention is illustrated by way of example, and not necessarily by way of limitation in the figures of the accompanying drawings in which like reference numerals refer to similar elements.

FIG. 1 is a block diagram of a conventional data network facilitating a traditional electronic commerce business model;

FIG. 2 is a block diagram of a data network incorporating an electronic commerce collaboration agent, in accordance with one embodiment of the present invention;

FIG. 3 is a block diagram of an example electronic commerce collaboration agent incorporating the teachings of the present invention, in accordance with one example embodiment of the present invention;

FIG. 4 is a graphical illustration of an example data structure comprising a collaboration database, in accordance with one aspect of the present invention;

FIG. 5 is a graphical illustration of an example data structure comprising an inventory database;

FIG. 6 is a graphical illustration of an example data structure comprising a product configuration database;

FIG. 7 is a graphical illustration of an example data structure comprising customer search information;

FIG. 8 is a flow chart of an example method for establishing electronic commerce collaboration associations, according to one aspect of the present invention;

FIG. 9 is a flow chart of an example method facilitating dynamically collaborative electronic commerce, in accordance with one aspect of the present invention;

FIG. 10 is a flow chart of an example method for translating user configuration requests into orderable product information that traverses dealer and/or manufacturer specifications, according to one aspect of the present invention;

FIG. 11 is a flow chart of an example method by which the seller and/or dealers and/or manufacturers of a product can manage one or more aspects of the information contained within one or more of the data structures, according to one aspect of the present invention;

FIG. 12 is a flow chart of an example process by which vehicle configurations are seeded from inventory vehicles, according to one aspect of the present invention;

FIG. 13 is a graphical illustration of an example interface for establishing collaboration rules, according to one aspect of the present invention;

FIG. 14 is a graphical illustration of an example interface for entering/modifying information within an inventory database, according to one aspect of the present invention;

FIG. 15 is a graphical illustration of an example user interface facilitating dynamically collaborative electronic commerce, in accordance with the teachings of the present invention;

FIG. 16 is a block diagram of an example computing system incorporating the innovative collaboration agent, according to one example embodiment of the present invention; and

FIG. 17 graphically illustrates an example storage medium comprising a plurality of instructions which, when executed, cause an executing machine to implement the teachings of the present invention in accordance with yet another embodiment of the present invention.

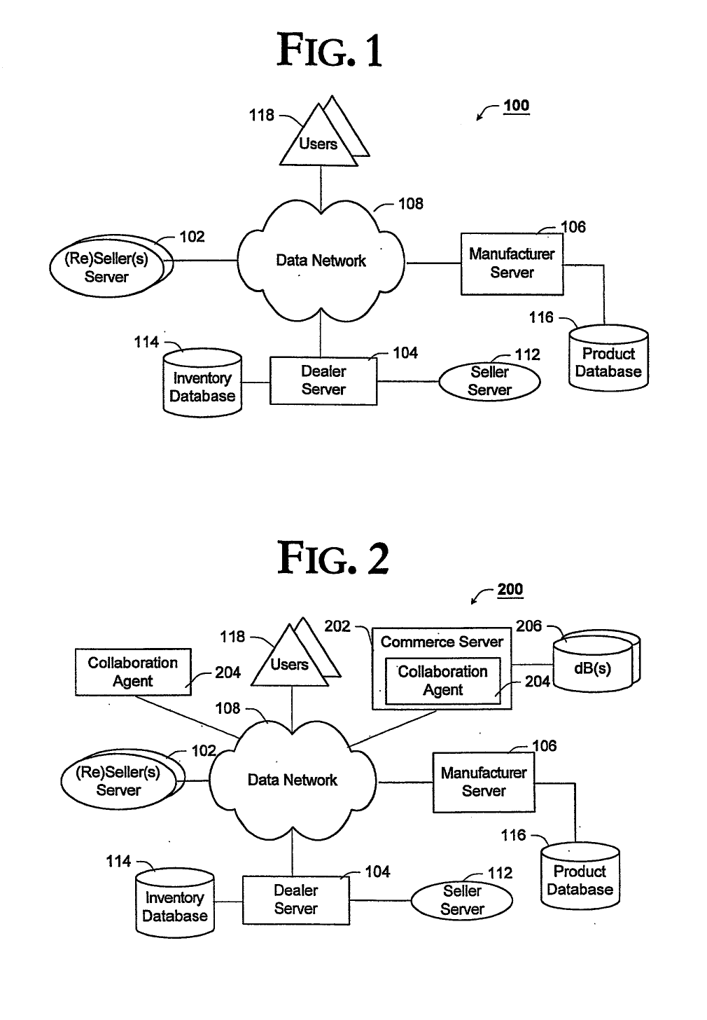

### DETAILED DESCRIPTION

The present invention is generally drawn to a system and related methods to facilitate dynamically collaborative commerce over a data network. According to one example implementation of the present invention, introduced more fully below, an innovative collaboration agent incorporating the teachings of the present invention is introduced. The collaboration agent enables otherwise digitally disparate providers (merchant/sellers, dealers, manufacturers, etc.) to agree to terms and conditions through which they may cooperatively participate in a commercial transaction over a data network. In this regard, collaboration agent provides database management services, data translation services, and collaboration management. According to one embodiment, collaboration agent manages user-initiated commercial transactions on behalf of the collaboration partners. Those skilled in the art will appreciate that the collaboration agent beneficially merges otherwise digitally disparate providers into what appears, from the user perspective, a cohesive, integrated business. In this regard, the present invention overcomes many of the limitations commonly associated with prior art electronic commerce platforms, providing for an improved user and provider commerce experience.

For ease of explanation and clarification, the present invention is often described with reference to an automotive sales environment. Although introduced in the context of such an example implementation, however, those skilled in the art will appreciate that the teachings of the present invention may readily be applied to any of a number of alternative electronic commerce implementations such as, for example, home electronics, flowers, legal and accounting services.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Data Network Facilitating Collaborative Commerce

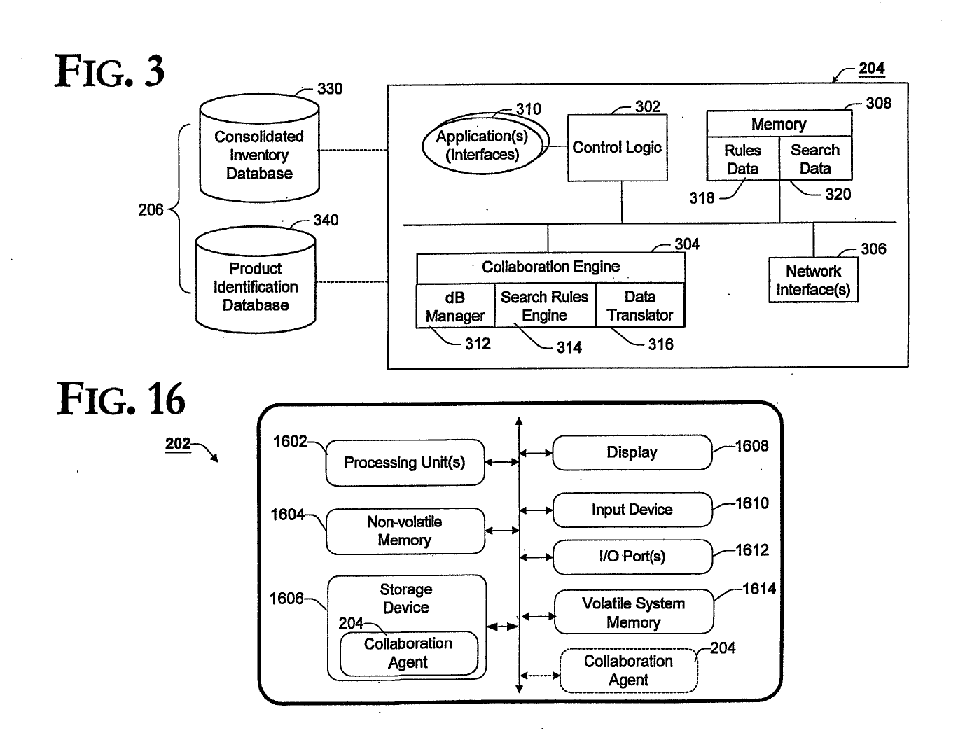

FIG. 2 is a block diagram of a data network incorporating an electronic commerce collaboration agent, in accordance with one embodiment of the present invention. Those skilled in the art will appreciate that, but for commerce server 202 including collaboration agent 204, network 200 is comprised substantially of the digitally disparate elements of the conventional data network 100. That is, data network 200 is depicted comprising one or more (re)seller server(s) 102 coupled to dealer server(s) 104 and manufacturer server(s) 106 via data network communication means 108. In this regard, data network 200 facilitates conventional electronic commerce in much the same manner as data network 100. The introduction of an commerce server 202 including the innovative collaboration agent 204 and associated data sources 206, however, facilitates seemingly integrated electronic commerce by digitally disparate providers (e.g., seller(s), dealer(s) and/or manufacturer(s)) that was heretofore unavailable.

As introduced above, for ease of explanation only, the teachings of the present invention will be developed within the context of an automotive sales environment. In accordance with the example embodiment, data communication network 108 represents the Internet; seller(s) server 102 represents one or more web-sites facilitating car research/sales for requesting users 118; dealer server(s) 104 represent the dealer management system (DMS) employed by most dealers to manage most aspects of their business including, for example, inventory management; manufacturer server(s) 106 represent one or more sources for accurate product information, such as that often provided by the manufacturer itself. It should be appreciated that each of the dealer and manufacturer may also offer e-tail web-sites (e.g., seller server 112) with which to sell their product inventory.

As will be developed more fully below, collaboration agent 204 provides a number of features and/or services designed to provide a seemingly integrated commercial presence for commerce participants. In this regard, collaboration agent 204 enables providers (e.g., sellers, dealers, and manufacturers) to manage their commercial relationship; translates information between the often digitally disparate computing environments of the providers, and provides a clearinghouse for commercial transactions initiated through it to the providers. A more detailed description of the architectural element(s) of collaboration agent 204 and their associated feature(s) is provided below, with reference to FIG. 3.

Example Collaboration Agent

FIG. 3 is a block diagram of an example electronic commerce collaboration agent incorporating the teachings of the present invention, in accordance with one example embodiment of the present invention. In accordance with the illustrated example implementation of FIG. 3, collaboration agent 204 is depicted comprising control logic 302, a collaboration engine 304, network interface(s) 306, memory 308 and one or more application(s) 310, each coupled as depicted. According to one aspect of the present invention, to be described more fully below, collaboration engine 304 includes a data manager 312, a search rules engine 314 and a data translator 316. Memory 308 is depicted comprising elements associated with rules data 318 and search/transaction history data 320. As introduced above, collaboration agent 204 relies on associated data stores to implement certain features, described more fully below. In this regard, collaboration agent 204 is depicted in FIG. 3 coupled to a consolidated inventory database 330 and a product identification database 340. While depicted as residing external to the collaboration agent 204, those skilled in the art will appreciate that such databases 206 may well be integrated within collaboration agent 204 without deviating from the spirit and scope of the present invention.

According to one implementation, collaboration agent 204 is selectively invoked by a higher-level application executing on, for example, server 202. In this regard, collaboration agent 204 must communicatively interact with external logic (e.g., such an application). The control of this and other functions of collaboration agent 204 is performed by control logic 302. More particularly, control logic 302 selectively invokes an instance of one or more of the features of collaboration engine 304 in response to commands received from such higher-level applications, and/or from commands directly received from a user and/or a provider. As used herein, control logic 302 is intended to represent any of a wide variety of control logic known in the art such as, but not limited to, processor(s), controller(s), application specific integrated circuit(s) (ASIC), programmable logic device(s) (PLD), and the like. In accordance with one embodiment, control logic 302 is intended to represent a series of executable instructions which, when executed by a host processor, implement the control functions described herein.

Collaboration engine 304 includes functional elements which, when selectively invoked by control logic 302, facilitate electronic commerce between digitally disparate providers. In accordance with the illustrated example embodiment of FIG. 3, collaboration engine 304 is depicted comprising a database management utility 312, search rules engine 314 and a data translator utility 316. Although depicted as integrated within a common collaboration engine 304, those skilled in the art will appreciate that one or more of the database manager 312, search rules engine 314 and/or the data translator may well be separated out into a distinct functional element.

Database manager 312 is selectively invoked to populate and manage information resident within the associated databases 206. In accordance with the illustrated example implementation of FIG. 3, database manager 312 is invoked to manage information within the consolidated inventory database 330 and/or the product identification database 340. In this regard, database manager 312 includes management features which actively solicit product and inventory information from participating providers. In accordance with one example implementation, the retrieved information is passed through data translator 316, which translates the received information into a collaboration agent-specific format. In addition, database manager 312 also includes a data management function which, when invoked, enables an administrator and/or provider to modify certain of the product attribute information of products for which they are authorized. According to one implementation, for example, a dealer may review and scrub information associated with their inventory to correct translation errors, provide additional information regarding the product, update price, terms and/or availability, etc.

As used herein, search rules engine 314 includes collaboration and data acquisition management features. As used herein, the collaboration management features of search rules engine 314 enable a provider (seller, dealer, manufacturer), to identify other providers with which to collaborate, and to define the terms and conditions of the relationship. Initially, an instance of search rules engine 314 is selectively invoked by a provider to identify other providers (e.g., seller(s), dealer(s) and/or manufacturer(s)) within the network with which they want to establish a virtual commercial relationship, and the terms and conditions of the relationship. Subsequently, as a user initiates a search for a product and/or product configuration from one of the collaboration providers, an instance of search rules engine 314 is invoked to control which providers are solicited, under particular search constraints.

Data translator 316 is selectively invoked by collaboration engine 304 to translate provider-specific information into collaboration-centric terms utilized by the collaboration agent 204 and/or plain English terms intended to ease understanding by the end-user. Those skilled in the art will appreciate that certain industries such as, for example, the automotive industry, utilize attribute codes to identify particular attributes of a product. In an industry such as the automotive industry, tens to hundreds of attribute codes may well be required to fully specify a particular product configuration. Making the task even more difficult is the fact that individual companies within the industry may, and often do, utilize separate, unique attribute codes within their company.

According to one implementation, data translator 316 is to build data structures of available product. That is, according to one implementation, data translator 316 is invoked as an offline process by the collaboration provider as a means of populating one or more of the data structures comprising product inventory. In this regard, data translator 316 receives inventory information from one or more providers and translates manufacturer and/or dealer specific attribute codes into collaboration-centric attribute codes used by collaboration agent 204 to describe product attributes of inventory across manufacturer and/or dealers.

In accordance with the illustrated implementation described above, the data translator 316 is periodically invoked to update and manage the inventory of associated data structures. It will be appreciated, however, that dealer/manufacturer inventory of available products may change more frequently. Accordingly, in accordance with one aspect of the present invention, data translator 316 may well be dynamically invoked to access available dealer/manufacturer/seller inventory, translate the retrieved information into collaboration-centric/plain-English, and present at least a subset of such results to a requesting user. In this regard, the dynamically invoked data translator 316 supports an implementation with a distributed inventory data-structure model, wherein collaboration agent 204 relies solely on the inventory data-structures of sellers/dealers/manufacturers.

To facilitate accurate data generation for the user, collaboration agent 204 utilizes data translator 316 in conjunction with a cross-referenced list of at least a subset of available product codes to translate user product attribute requirements into corresponding product codes known to the providers. According to one aspect of the invention, to be described more fully below, data translator 316 utilizes a process colloquially referred to as “deep seeding”, to automatically seed an inventory search result with options identified on products currently available within inventory. That is, rather than providing a user with all available product configurations, data translator 316 seeds the product configurations for user-selected product style with those configurations identified on current product inventory. As introduced above, when presenting search results to the user, data translator 316 presents the product configurations in plain-English for the ease and convenience of the user.

In accordance with another innovative aspect of collaboration agent 204, collaboration agent 204 through any of a number of interfaces (generated within or without of collaboration agent) can receive lifestyle or “product use” information from the user and translate those more esoteric characteristics into product attributes. More particularly, in accordance with one example implementation, data translator 316 can also translate non-product related information associated with the product into product specific codes/attributes. In this regard, collaboration agent 204 facilitates commerce to those who may not be so technically inclined, or versed in the different aspects of the product they wish to purchase.

Network interface(s) 306 is intended to represent any of a wide variety of communication interfaces necessary to enable collaboration agent 204 to communicate with other network devices. In accordance with the illustrated example implementation, where collaboration agent 204 communicates with providers via the Internet, the network interface(s) 306 include facilities to interface with the Internet.

Memory 308 is depicted comprising rules data 318 and search/transaction history data 320. According to one example implementation, rules data 318 are the collaboration rules defining the terms and conditions of the relationship(s) between digitally disparate providers. According to one implementation illustrated more fully below, the rules data 318 maintains information regarding which seller(s) are associated with which dealer(s) and/or manufacturer(s), and the terms and conditions of each of those relationships.

In addition to the rules data 318, collaboration engine 304 maintains a history of search requests and/or a transaction history in search data 320. According to one implementation, the search data is used by one or more application(s) 310 to generate market statistical information as a service for the providers. As used herein, memory 308 is intended to represent any of a wide variety of volatile and/or non-volatile memory devices known in the art.

In accordance with the illustrated example implementation of FIG. 3, collaboration agent 204 is endowed with application(s) 310. As used herein, application(s) 310 are intended to represent any of a wide variety of applications including, for example, statistical tools, report generation tools, and user interface(s). According to one implementation, for example, application(s) 310 include graphical user interface(s) (GUIs) to facilitate management of the collaboration engine 304 features. An example of such interfaces is provided below, with reference to FIGS. 12-14.

Accordingly, collaboration engine 304 facilitates the establishment of commercial relationships between sellers, dealers and manufacturers without regard to the individual server platforms, operating systems, and information management tools used by these digitally disparate providers.

Example Data Structure(s)

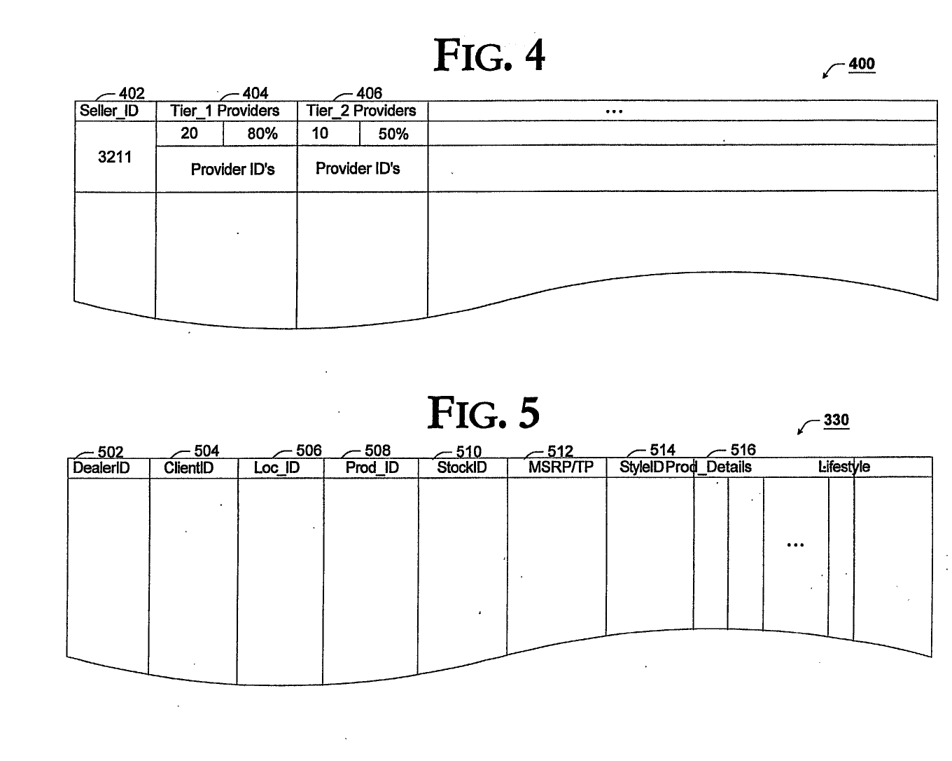

FIG. 4 is a graphical illustration of an example data structure comprising a collaboration rules database, in accordance with one embodiment of the present invention. In accordance with the illustrated example implementation of FIG. 4, the collaboration rules database 400 is presented as a one-dimensional data structure comprising a seller_ID field 402, and a plurality of fields 404, 406, etc. wherein collaboration partners are identified (e.g., via provider IDs such as dealer_IDs and/or manufacturer_IDs). In accordance with the illustrated example implementation, each of the collaboration partners are further divided into tiers in order of preference. That is, each of the providers may identify a relative priority, or preference, of collaboration partners.

Within each of the tier fields 404, 406, etc. a provider may define the search conditions for that tier and, accordingly, the terms and conditions under which a search within a subordinate tier is engaged. In accordance with the illustrated example, tier 1 404 includes the requirements that 20 search results be returned, each having a minimum relevance threshold of 80%. In addition, the tier 1 field 404 will include dealer_IDs for those providers seller wishes to prioritize. In tier 2 406, the search requirements state call for 10 search results, each having a minimum relevance threshold of 50%, otherwise a subsequent search within tier 3, etc. will be performed.

Although depicted as seller-centric, those skilled in the art will appreciate that this is for purposes of explanation only, as database manager 312 provides a myriad of means by which each of the providers can define the terms and conditions of the collaboration relationship. That is, each of the providers may participate in tier classification. Moreover, in certain implementations, dealers and manufacturers can restrict which products and/or product configurations are sold by each of the sellers. For example, dealer 1 may be a tier_1 provider of Corvette's for one seller, but a tier_3 provider of all other products. Alternatively, dealer 1 may decide and configure collaboration database such that seller 3211 is unable to access or sell anything but the Corvette line and then, if and only if, seller 3211 designates dealer 1 as a first tier provider. Similarly, dealer 1 may decide that it only wants to collaborate with those sellers that have designated it as a tier_1 dealer within the collaboration database.

FIG. 5 is a graphical illustration of an example data structure comprising a consolidated inventory database, in accordance with one aspect of the present invention. As introduced above, database manager 312 periodically retrieves inventory content from select providers (e.g., dealers and manufacturers). The data is translated into a collaboration agent-centric format (e.g., by data translator 316), and stored in database 330. In accordance with the illustrated example implementation of FIG. 5, data structure 500 is presented comprising a provider_ID field 502, client_ID 504 field, a location_ID field 506, a product_ID field 508, a stock_ID field 510, a pricing field 512, a styleID field 514, product description field(s) 516 and lifestyle description field(s) 518. Each of fields 502-514 are adequately defined by their description and require no further explanation. It will be appreciated that, for purposes of facilitating commercial transaction, the pricing field 512 may include both a manufacturers suggested retail price (MSRP) as well as a threshold price (TP) that the provider is willing to accept.

In addition to the foregoing, inventory database includes a number of fields 516, 518 devoted to product information and associated lifestyle information, respectively. According to one implementation, each of the unique product codes associated with a product by the manufacturer is translated into collaboration agent standard detail codes, to facilitate searches and comparison across product lines. Moreover, in accordance with one aspect of the present invention, certain of the detail codes are associated with lifestyle information, facilitating searching of products by lifestyle parameters rather than product parameters. For example, in accordance with our automotive illustration, a two-door car may be associated with “sporty”, while a four-door may be associated with “family car” or “roomy”. According to one implementation, collaboration agent 204 supports searches based on a ranking of prestige, performance, safety, roominess, affordability, value, handling, reliability, family-friendly, luxury, power, feature-rich/loaded, etc. Moving away from the automotive example to another example, say the purchase of stereo equipment, collaboration engine 204 in conjunction with inventory database 330 would support a search for a stereo based on “color of the room”, “size of the room”, “purpose of the room”, etc. within which the stereo is to be used.

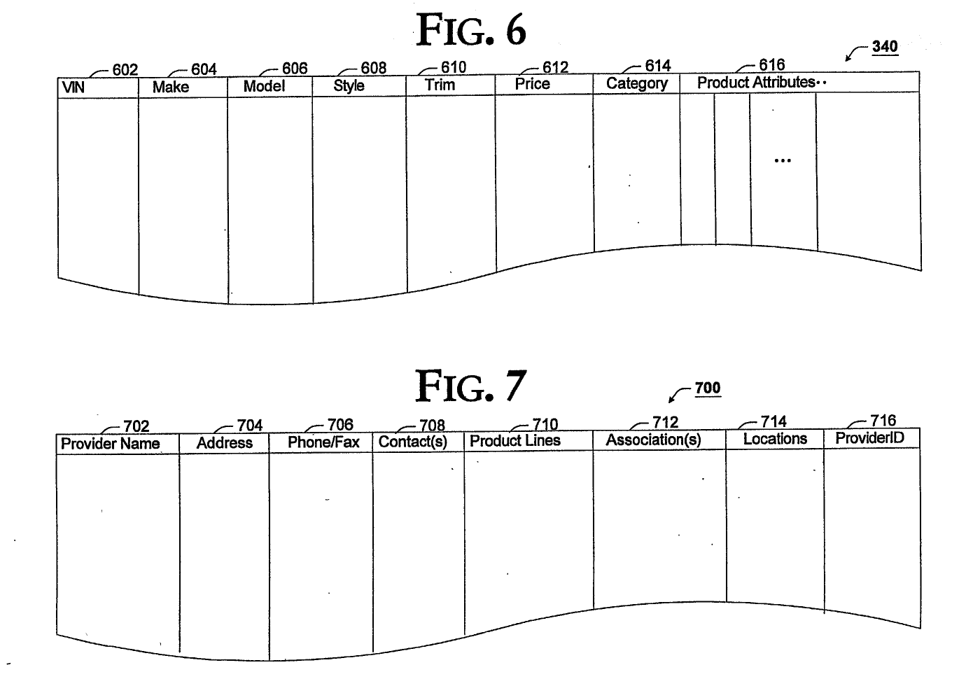

FIG. 6 is a graphical illustration of an example data structure comprising a product configuration database. In accordance with the illustrated example automotive implementation of FIG. 6, a data structure 340 comprising a product configuration database is presented. As shown, the database includes fields dedicated to the vehicle identification number 602, the make 604, model 606 and style 608 of a vehicle, the trim 610, price 612, vehicle category 614 (e.g., SUV, sedan, coupe, etc.) and vehicle attributes 616. As above, the information contained within each of the fields is self-explanatory

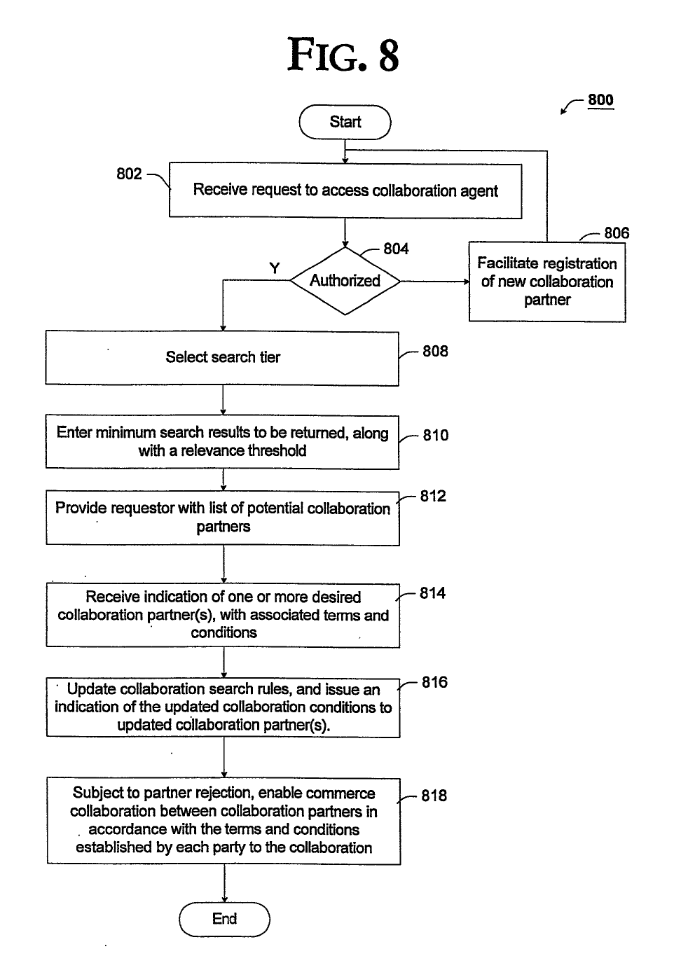

FIG. 7 is a graphical illustration of an example data structure comprising provider information. An analogous database may well be maintained for users (i.e., customers) of the collaboration agent. In accordance with the illustrated example implementation of FIG. 7, a number of fields are provided for the provider name 702, address 704, phone/fax information 706, contacts and associated passwords 708, representative product lines 710, collaboration associations 712, the number of locations 7114 and the provider identifier. As above, the information contained within each of the fields is self-explanatory and, accordingly, will not be discussed further.

Example Implementation and Operation

Having introduced the functional and architectural elements of the present invention with reference to FIGS. 2 through 7, associated methods facilitating dynamically collaborative commerce is presented with reference to FIGS. 8 through 14. For ease of illustration, and not limitation, the development of such embodiments will be made with continued reference to the system and architectural detail of FIGS. 2 through 7.

FIG. 8 is a flow chart of an example method for establishing electronic commerce collaboration associations, according to one aspect of the present invention. In accordance with the illustrated example implementation of FIG. 8, the method begins with block 802 wherein commerce server 202 receives a request to access collaboration agent 204. More particularly, as introduced above, a provider (seller, dealer, manufacturer) accesses collaboration management features of collaboration agent 204 to establish, delete or modify existing collaboration rules.

In block 804, collaboration agent 204 makes a determination of whether the provider is actually authorized to enter the site. In accordance with one example implementation, if the provider is already registered with the collaboration agent 204, upon such registration, a cookie was installed on the accessing computer to facilitate authorization on subsequent accesses. If the cookie is not identified, collaboration agent 204 prompts the provider for registration information, block 806, and the process returns to block 802.

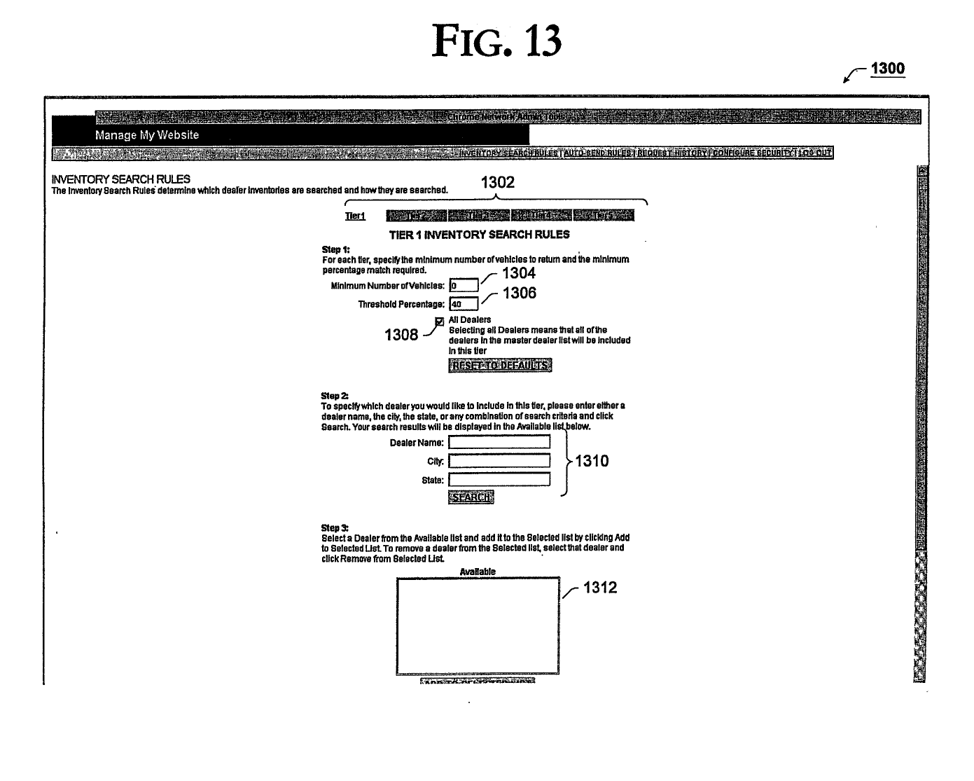

In block 808, access being authorized by collaboration agent 204, collaboration agent 204 generates an interface through which the user can define/modify collaboration rules. More particularly, control logic 302 of collaboration agent 204 selectively invokes an instance of search rules engine 314, which generates a management interface through which the user can define/update collaboration rules. An example of just such an interface is provided with reference to FIG. 13.

Turning briefly to FIG. 13, a graphical illustration of an example interface for establishing collaboration rules is presented, in accordance with one aspect of the present invention. In accordance with the illustrated example embodiment of FIG. 13, the accessing dealer/manufacturer/seller can specify, in 1302, which tier of partnerships they wish to manage, the minimum number of search results 1304 and relevancy percentage threshold 1306 for providers within the tier. Alternatively, the user can simply elect to collaborate with all available providers 1308. In block 1310, a user can search for specific providers by name, city, state, etc., and/or select providers from a master provider list 1312. In this regard, a dealer/manufacturer/seller can unilaterally establish a proposed set of collaboration rules with one or more commercial outlets, e.g., commerce servers, Internet service providers, etc. through which their product will be made available over a data network.

Returning to FIG. 8, collaboration agent 204 receives indications of one or more desired collaboration partners, with associated terms and conditions, block 810. According to one example embodiment, the indication may include one or more of a dealer name/ID, a threshold search result, relevance threshold, and the like. Given the received information, search rules engine 314 accesses and updates the search rules data 320 of memory 308. The process of defining collaboration partners and tier definitions continues until complete.

In block 814, subject to collaboration partner rejection/modification, collaboration agent 204 facilitates commercial collaboration between collaboration partners in accordance with the terms and conditions established by each party to the collaboration.

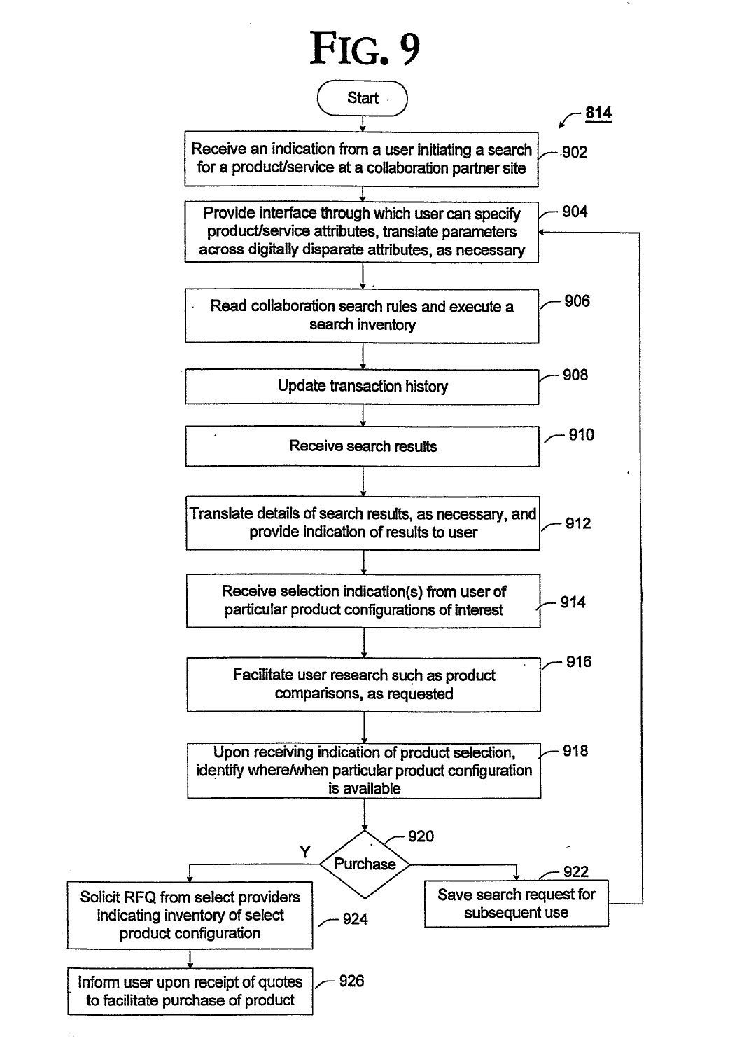

FIG. 9 is a flow chart of an example method facilitating dynamically collaborative electronic commerce, in accordance with one aspect of the present invention. In accordance with the illustrated example embodiment of FIG. 9, the method of block 814 begins with block 902, wherein collaboration agent 204 receives an indication from a user initiating a search for a product/service. According to one implementation, the indication is received directly from the user, i.e., via a user interface 310 provided by the collaboration agent 204. In an alternate implementation, the indication is received from a collaboration partner (e.g., seller 102) server. Often, multiple indications will be simultaneously received from any of a number of alternate sources, each resulting in separate invocation of appropriate functional elements of collaboration agent 204.

In block 904, collaboration provides an interface through which the user can specify product/service attributes. An example of just such an interface is provided for purposes of illustration with reference to FIG. 15. More particularly, FIG. 15 illustrates an example user interface suitable for automotive applications wherein a user can specify one or more of a product manufacturer, model, year of production, the number of miles, and location of the vehicle.

In block 906, upon receiving the search requirements, collaboration agent 204 selectively invokes an instance of search rules engine 314 to read collaboration search rules and execute an inventory search according to such rules. According to one example implementation, search engine 314 initiates a search of data structures comprising inventory information from a number of providers (dealers/sellers/manufacturers) which is scrubbed by data translator 316 to conform to the collaboration-centric/plain English terminology used by collaboration agent 312. In an alternate implementation, search engine 314 initiates a search of data structures associated with select individual provider(s), and selectively invokes data translator 316, as necessary, to translate user requirements to/from the provider-specific product attribute codes from/to collaboration centric/plain-English terms which are readily understandable by the end-user.

In accordance with one embodiment, collaboration agent 204 updates a transaction history 320 with a record of the current search, block 908.

In block 910, search rules engine 314 receives the search results from solicited providers. In accordance with one aspect of the present invention, if the search requirements are satisfied for the particular tier no further searches are invoked. If, however, the number of search results, or the minimum number of relevant search results do not meet a tier threshold, search rules engine 314 may initiate another search of a subsequent tier of providers to satisfy the users search request.

In block 912, collaboration agent 204 invokes an instance of data translator 316, as necessary, to translate select details of the search results into plain English, whereupon collaboration agent 204 provides a listing to the requesting user. It will be appreciated by those skilled in the art that the search results will be provided to the user through the same interface (e.g., seller server 102) used to access the collaboration system.

In block 914, collaboration agent 204 receives selection indication(s) from the user denoting particular products and/or product configurations of interest. According to one implementation, collaboration agent 204 facilitates further research by the user through comparison applications 310, analysis applications 310, financial calculator applications 310, and the like, block 916.

In block 918, upon receiving an indication of product selection, collaboration agent 204 identifies where and when the selected product is available, generating a prompt for the user to enable purchase of the product.

In block 920, if the user decides not to purchase the product, the process continues with block 922, wherein collaboration agent saves the search request for subsequent use.

If, however, in block 920 the user generates an indication to purchase the product, collaboration agent 204 solicits a request for quote (RFQ) from one or more select providers denoting availability of the requested product/product configuration.

In block 926, upon receiving a response, collaboration agent 204 notifies the user of a response to their RFQ, and facilitates completion of the purchase.

According to one implementation, once a product of interest is identified, a purchase process similar to that described in co-pending application Ser. No. 09/188,863 may be employed to facilitate completion of the purchase process.

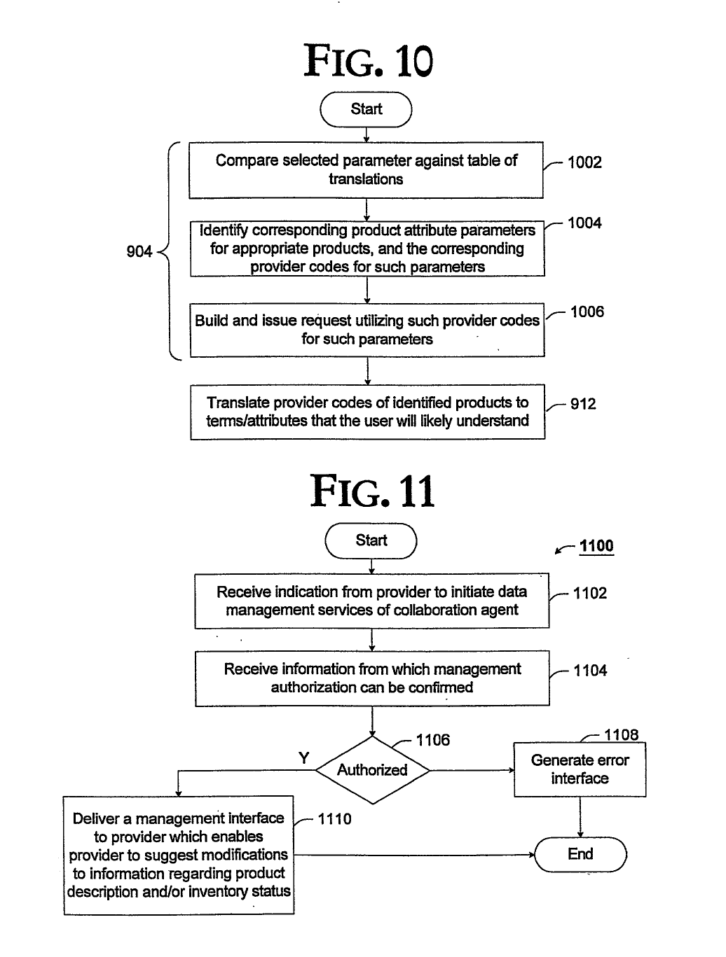

Fig. 10 is a flow chart of an example method for translating user configuration requests into orderable product information that traverses dealer and/or manufacturer specifications, according to one aspect of the present invention. In accordance with the illustrated example implementation of FIG. 10, the method begins with block 1002 wherein collaboration agent 204 invokes an instance of data translator 316 to compare selected parameter against a table of translations/conversions. In block 1004, data translator 316 identifies corresponding product attribute parameters for appropriate products, and the corresponding provider codes for such parameters.

In block 1006, data translator builds the search request utilizing such provider codes for such parameters. The results of such a search are subsequently translated by data translator 316, as above, to terms/attributes the user is more likely to understand, e.g., plain English descriptors, block 912.

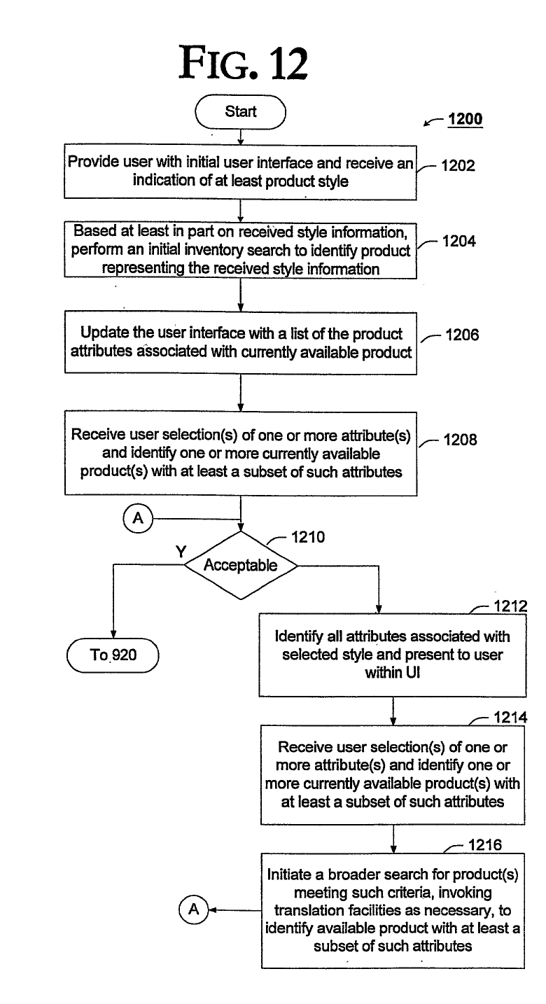

FIG. 11 is a flow chart of an example method by which the seller and/or dealers and/or manufacturers of a product can manage one or more aspects of the information contained within one or more of the data structures, according to one aspect of the present invention. In accordance with the illustrated example embodiment of FIG. 11, collaboration agent 204 invokes an instance of database management utility 312 in response to a received indication from a provider to access/update database content. That is, in response to a request from a provider to access/update one or more of associated databases 206, collaboration agent 204 invokes an instance of dB manager 312, block 1102. In block 1104, dB manager receives information from the provider to facilitate authorization of the requesting provider. As indicated above, the information may be automatically gathered from the accessing provider, e.g., from a cookie. Alternatively, the user may be prompted for information with which to authorize access, block 1104.

In block 1106, dB manager 312 determines whether the provider is authorized and, if not, generates an error for the user, block 1108.

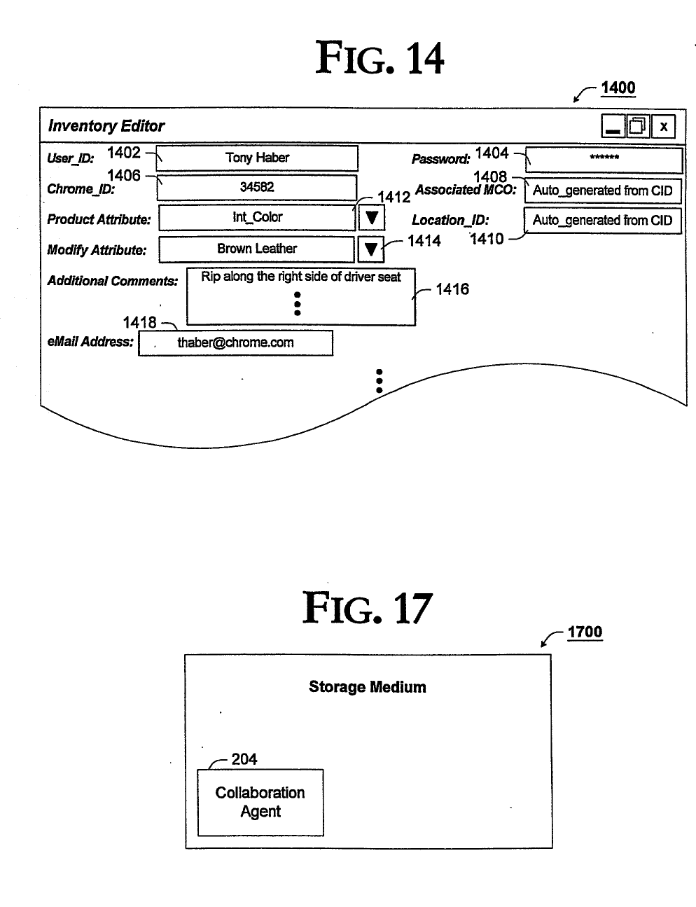

If, the requesting provider is authorized in block 1106, dB manager delivers a management interface 310 to provider which enables the provider to suggest modifications to information regarding product description and/or inventory status, block 1110. An example of a just such an interface is provided with reference to FIG. 14.

FIG. 14 graphically illustrates an example interface through which an authorized provider can manipulate data content in one or more of associated databases 206, in accordance with one aspect of the present invention. In accordance with the example implementation of FIG. 14, interface 1400 includes identification and password fields 1402, 1404 through which authorization may be achieved. Fields 1406 through 1410 are identification fields for a particular product in inventory. According to one implementation, if the information is not available within the inventory, the user may enter new values, thereby facilitating provider population of databases 206. Fields 1412-1416 enable a provider to modify any of a number of product attribute descriptions, as well as providing additional comments that might not be associated with simply a stock number from a dealer/manufacturer. In block 1418, the provider may insert an email address to which a confirmation of product description update is sent by dB manager 312.

FIG. 12 illustrates a flow chart of an example method for dynamically generating and managing the content of a user interface to speed a user's identification of available product inventory, according to one aspect of the present invention. As shown, the method begins with block 1202 wherein a user accesses a commerce server implementing collaboration agent 204 and completes an initial product survey (e.g., depicted in FIG. 15) wherein the user provides at least product style information.

In block 1204, based at least in part on the style information, collaboration agent 204 performs an initial search of inventory data structure(s) to identify product adhering to the style information. Once such inventory is identified, a list of the different product attributes for each of the identified products is developed, including relationships between the attributes.

In block 1206, collaboration agent 204 updates the user interface provided to the user with a list of the product attributes associated with product currently available in inventory for selection by the user.

In block 1208, collaboration agent 204 identifies one or more selections of particular product attributes by the user and translates such product attribute selection(s) into one or more product(s) which meet the user criteria. Unlike prior art commercial systems, which enable a user to build a desired product configuration based on manufactured product attributes even if that particular configuration is not readily available, collaboration agent 204 provides the user with a list of only those attributes associated with available product inventory. In this way, collaboration agent speeds the product identification process by ensuring that a configured product is available within current inventory, eliminating the iterative process commonly associated with the prior art.

In block 1210, collaboration agent 204 receives an indication of whether one or more of the identified product(s) is acceptable to the user. If so, the process continues with block 920 (of FIG. 9). If not, the process continues with block 1212, wherein collaboration agent 204 assembles a list of all product attributes manufactured for a particular product style, regardless of whether the current product inventory is populated with product representing such product configuration.

In block 1214, collaboration agent 204 receives an indication of the additional desired product attributes and, in block 1216, collaboration agent 214 initiates a broader search of providers to identify the desired product configuration, utilizing the resources of data translator 316 described above, as necessary. The process then continues with block 1210.

Example Host Computing System

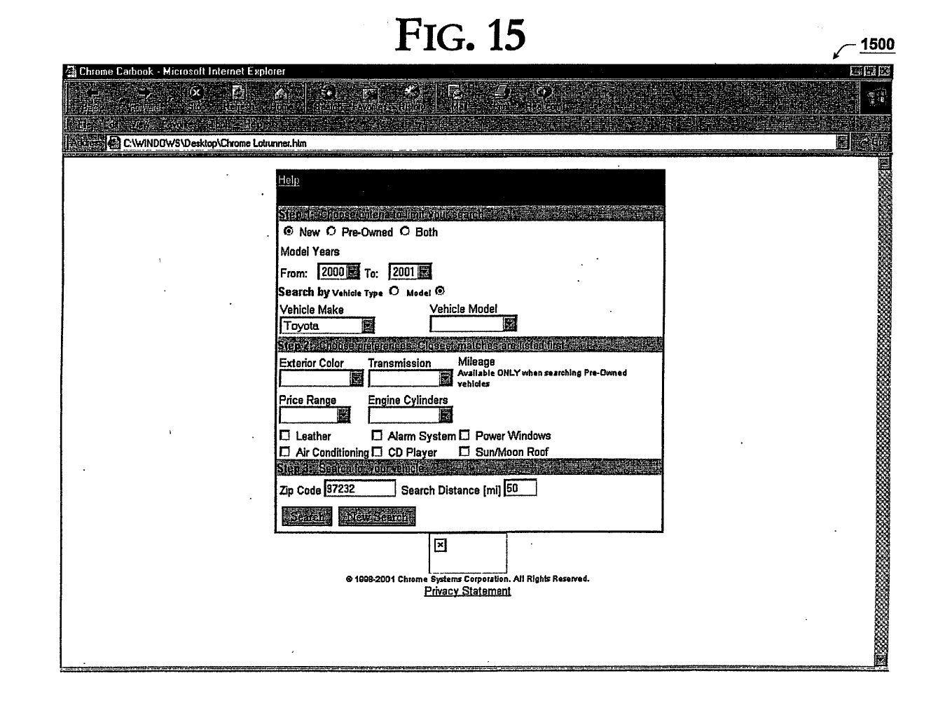

FIG. 16 is a block diagram of an example computing system 1600 suitable for use as server 202, hosting the innovative collaboration agent 204 of the present invention. As introduced above, server 202 is intended to represent any of a plurality of computing devices known in the art. As depicted in the illustrated example embodiment of FIG. 16, server 1600 includes one or more processing units 1602, non-volatile memory 1604, and a storage device 1606 including, according to one example implementation, executable instructions that when executed by one or more processors 1602, implement at least certain aspects of the collaboration agent 204, described above. In accordance with another implementation, denoted by dashed lines, collaboration agent 204 is implemented in hardware as an accessible feature of server 1600.

Computing system 1600 also includes one or more input/output (I/O) ports 1612 and a volatile system memory 1614. In addition, certain implementations of computing system 1600 include one or more input devices 1610 and a display device 1608, coupled as shown. It is to be appreciated that although the collaboration agent 204 is implemented as a software program, computing system 1600 may alternatively support a hardware implementation as well. In this regard, but for the description of computing system 1600, the following description is intended to be merely illustrative, as computer systems of greater or lesser capability may well be substituted without deviating from the spirit and scope of the present invention.

As used herein, processing unit(s) 1602 of server 1600 are programmed by means of executable instructions stored at different times in the various computer-readable storage media of the computer, e.g., volatile system memory 1614, non-volatile memory 1604, L1 or L2 cache memory (not shown) of the processing unit(s) 1602 and the like. Application programs, operating systems, and other computing software are usually distributed on removable storage media such as, for example, floppy disks or CD-ROMs. From there, they are installed or loaded into the secondary memory of a computer, e.g., a mass storage device. At execution, they are loaded at least partially into the computer's primary electronic memory 1614. Accordingly, it is to be appreciated that the invention described herein includes these and other various types of computer-readable storage media when such media contain instructions or programs for implementing the innovative steps described above in conjunction with a microprocessor or other data processor. The invention also includes the computer itself when programmed according to the methods and techniques described above. Furthermore, certain sub-components of the computer may be programmed to perform the functions and steps described above. The invention includes such sub-components when they are programmed as described. In addition, the invention described herein includes data structures, described above, as embodied on various types of memory media.

As used herein, but for the inclusion of collaboration agent 204, processing unit(s) 1602, non-volatile memory 1604, storage device 1606, input device 1610, display 1608, I/O ports 1612 and volatile system memory 1614 are each intended to be illustrative of such devices as they are well known in the art. That is, collaboration agent 204 does not require any special features from a typical computing system for implementation. Thus, these elements need not be described further.

Alternate Embodiments

FIG. 17 is a block diagram of a storage medium having stored thereon a plurality of instructions including instructions which, when executed, facilitate an implementation of collaboration agent 204, according to yet another embodiment of the present invention. In general, FIG. 17 illustrates a storage medium/device 1700 having stored thereon a plurality of machine-executable instructions including at least a subset of which that, when executed, implement the innovative collaboration agent 204 of the present invention.

As used herein, storage medium 1700 is intended to represent any of a number of storage devices and/or storage media known to those skilled in the art such as, for example, volatile memory devices, non-volatile memory devices, magnetic storage media, optical storage media, and the like. Similarly, the executable instructions are intended to reflect any of a number of software languages known in the art such as, for example, C++, Visual Basic, Hypertext Markup Language (HTML), Java, eXtensible Markup Language (XML), and the like. In one embodiment, the executable instructions are Very High Speed Integration Hardware Description Language (VHDL) instructions, which describe to a manufacturing device how to implement the invention in an integrated circuit. Moreover, it is to be appreciated that the storage medium/device 1700 need not be co-located with any host system. That is, storage medium/device 1700 may well reside within a remote server communicatively coupled to and accessible by an executing system. Accordingly, the software implementation of FIG. 17 is to be regarded as illustrative, as alternate storage media and software embodiments are anticipated within the spirit and scope of the present invention.

Although the invention has been described in the detailed description as well as in the Abstract in language specific to structural features and/or methodological steps, it is to be understood that the invention defined in the appended claims is not necessarily limited to the specific features or steps described. Rather, the specific features and steps are merely disclosed as exemplary forms of implementing the claimed invention. It will, however, be evident that various modifications and changes may be made thereto without departing from the broader spirit and scope of the present invention. The present specification and figures are accordingly to be regarded as illustrative rather than restrictive. The description and abstract are not intended to be exhaustive or to limit the present invention to the precise forms disclosed.

The terms used in the following claims should not be construed to limit the invention to the specific embodiments disclosed in the specification. Rather, the scope of the invention is to be determined entirely by the following claims, which are to be construed in accordance with the established doctrines of claim interpretation.

In accordance with the foregoing, we claim the following:

### APPENDIX A

I hereby appoint BLAKELY SOKOLOFF TAYLOR & ZAFMAN LLP,a firm including: William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No.39,637; Donna Jo Coningsby, Reg. No. 41,684; Florin A. Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No.37,813; Justin M. Dillon, Reg. No. 42,486; Caroline T. Do, Reg. No. 47,529;.Sanjeet Dutta, Reg. No. P46,145; Matthew C. Fagan, Reg. No. 37,542; Tarek N. Fahmi, Reg. No. 41,402; Mark W. Farrell, Reg. No. 45,988; George Fountain, Reg. No. 36,374; James Y. Go, Reg. No. 40,621; James A. Henry, Reg. No. 41,064; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; Steven Laut, Reg. No. 47,736; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. 47,758; Joseph Lutz, Reg. No. 43,765; Michael J. Mallie, Reg. No. 36,591; Andre L. Marais, under 37 C.F.R. § 10.9(b); Raul D. Martinez, Reg. No. 46,904; Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Edwin H. Taylor, Reg. No. 25,129; Lance A. Termes, Reg. No. 43,184; John F. Travis, Reg. No. 43,203; Joseph A. Twarowski, Reg. No. 42,191; Kerry D. Tweet, Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafinan, Reg. No. 26,250; my patent attorneys, and Firasat Ali, Reg. No. 45,715 and Richard A, Nakashima, Reg. No. 42,023, my patent agents of BLAKELY SOKOLOFF TAYLOR & ZAFMAN LLP, with offices located at 12400 Wilshire Boulevard, 7th Floor, Los Angeles, California 90025, telephone (310) 207-3800, and Amin Zoufonoun, Reg. No. 48,065, my patent agent, with full power of substitution and revocation, to prosecute this application and to transact all business in the Patent and Trademark Office connected herewith.

1. An apparatus comprising:
a storage medium to store a plurality of collaboration rules; and
a collaboration agent, to provide an interface through which digitally disparate sellers, dealers and/or manufacturers agree to selectively participate in commercial transactions for requesting users, and to enable each of the sellers, dealers and/or manufacturers to define terms and conditions under which they selectively participate with one another to facilitate commercial collaboration between these otherwise digitally disparate providers.
